(19) United States
(12) Patent Application Publication
(10) Pub. No.: US 2015/0152618 A1
(43) Pub. Date: Jun. 4, 2015

(54) KINETIC DEICER AND METHODS OF USE THEREOF

(71) Applicant: Joseph J. Bertagnolli, Cheyenne, WY (US)

(72) Inventor: Joseph J. Bertagnolli, Cheyenne, WY (US)

(21) Appl. No.: 14/097,237

(22) Filed: Dec. 4, 2013

(51) Int. Cl. E02B 15/02; A01K 7/00

(52) U.S. Cl. CPC E02B 15/02; A01K 7/00

(57) ABSTRACT

Disclosed are devices, systems and methods for deicing fluids, including water. The disclosed devices, methods and systems impart kinetic energy to deice the fluid.

### CROSS-REFERENCE TO RELATED APPLICATION

This application is a continuation-in-part of co-pending U.S. patent application Ser. No. 13/287,025 filed Nov. 1, 2011, which claims the benefit of U.S. Provisional Patent Application No. 61/432,774 filed Jan. 14, 2011, both of which are incorporated by reference in their entirety herewith.

### BACKGROUND

When water is exposed to freezing temperatures, ice accumulates. For livestock water tanks, such icing prevents animals from drinking. Thus, farmers and ranchers must implement ways to keep stock water tanks from freezing so livestock can drink. To combat icing, heating devices can be introduced into the tank to increase the thermal energy of the water. Such devices, whether powered by electricity, propane or other fuels, require vast amounts of thermal energy to prevent freezing since the water temperature must be maintained above the freezing point. Although thermal systems can prevent icing, the systems are expensive to operate, lack portability, cannot be operated for more than a few hours on battery power, and must be checked frequently. Only two systems are generally known to be available to farmers and ranchers: electric stock tank heaters, which consume large amounts of electricity (presuming it is even available) or expensive propane flame type immersion heaters, which are also costly to operate especially with rising fuel costs. The practicality of either of these systems is extraordinarily limited. Thus, what is needed are deicing methods, systems and devices that does not require increasing the temperature of a fluid above its freezing point in order to maintain a liquid phase.

### SUMMARY

Disclosed are devices, systems and methods for deicing fluids, including water in watering tanks and troughs, and any other container where deicing is needed. The disclosed devices, methods and systems rely on kinetic energy, i.e., motion, instead of thermal energy, i.e., heat, to deice the fluid. In certain embodiments, the system comprises a pump which circulates water with sufficient kinetic energy to deice the fluid, event though the fluid is at or below its freezing point.

### BRIEF DESCRIPTION OF SEVERAL VIEWS OF THE DRAWINGS

FIG. 1 illustrates a simplified view of a kinetic deicing system according to an embodiment of the present invention.

FIG. 2 illustrates a view of an exemplary bracket useful for immersing a component recirculating pump for a deicing system adapted for use in a livestock water tank.

### DETAILED DESCRIPTION

Presented herein are devices, systems, and methods of deicing fluids including water. The disclosed devices, systems and methods do not rely on thermal energy to deice the fluid, thus, drastically reducing the amount of energy required to maintain the fluid in a liquid state. While not limited to use in animal watering tanks, such a system is in one embodiment specifically intended to allow animals to be watered in sub-freezing temperatures. The term “deicing” is to be construed as mitigating freezing, crystallization or gelling of fluids as well as preventing freezing, crystallization or gelling of the fluid when the fluid temperature drops below the fluid's freezing point. For example a kinetic deicing system is “deicing” a fluid where the system is imparting kinetic energy into a fluid in anticipation of the ambient temperature dropping below the freezing point of the fluid.

Regarding kinetic deicing systems, a “pump” is to be construed broadly as a water moving device, including for example paddles, paddle wheels, stirring bars, stirring baffles, stirring paddles, agitators, vibrators, bubblers, wave generators, gas diffusers, gas jets such as compressed air, recirculating pumps as described herein and any other device capable of imparting motion to deice a fluid. As described herein, the scope of embodiments of kinetic deicing system is not limited by the means in which motion is imparted to a fluid including water for example.

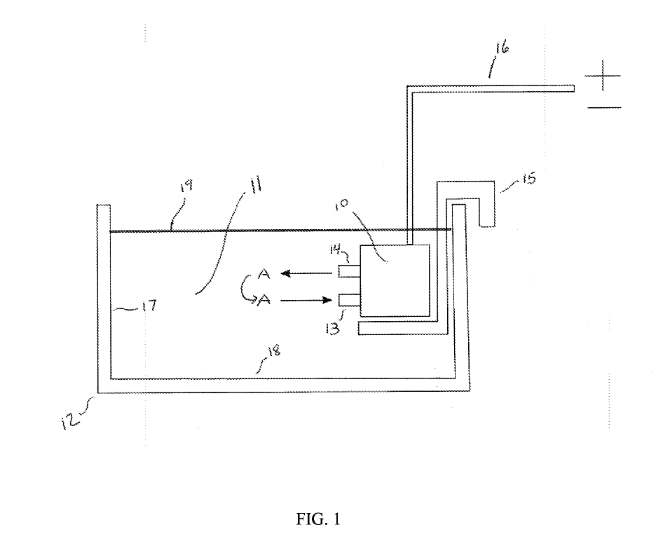

FIG. 1 presents a simplified cross-sectional view of a non-limiting embodiment of a kinetic deicing system for a fluid in an open-top container, comprising a recirculating pump 10 immersed in a fluid 11 which is retained in the container 12. In certain embodiments, the container is cylindrical, ovoid, rectangular, cubic or other shape. In certain other embodiments the container is an open-top water receptacle, such as a livestock water trough, water tank, bucket, pond, pool or birdbath. The immersed recirculating pump 10 comprises a fluid intake 13 and a fluid output 14, thereby allowing the fluid 11 in the container 12 to be recirculated A. The fluid may be recirculated in any direction that deices the fluid, and, in certain embodiments, the fluid is recirculated near the surface of the fluid or at the surface of the fluid. The term “recirculating pump” is intended to be construed broadly to include any means known in the art to circulate, move, or otherwise impart kinetic energy into a fluid by means of an intake and output including such means as an impeller, propeller, jet, peristaltic pump, bilge pump, piston pump, or any other form of pump. The system further comprises an attachment means whereby the recirculating pump 10 can be affixed to the container 12. For example, the attachment means can be a hanging bracket 15 attached to a recirculating pump 10 thereby anchoring the recirculating pump to fluid container 12 as exemplified in FIG. 1.

In certain embodiments, the recirculating pump 10 is in electrical communication 16 with a power source. While not being bound by any specific embodiment, the recirculating pump can operate using electricity from an AC or DC source. In certain embodiments, the DC source is a battery, including for example a 12V car battery or marine battery. In certain embodiments, a removable battery may be contained within the recirculating pump housing. In certain other embodiments, a battery can be connected to a solar or wind power electrical generating source in order to recharge the battery providing electricity to the pump. In other embodiments a converter is used to convert AC to DC, allowing connection of a DC-powered pump to household current. In certain other embodiments, a short in the power supply line can be prevented by including a ground fault interrupt in the electrical circuit, fuses or some combination thereof.

While the power consumption of a pump can vary, in certain embodiments the power consumption is 10.0 amps, 5.0 amps, 2.0 amps, 1.5 amps, 1.25 amps, 1.0 amps, 0.5 amps, 0.25 amps, 0.1 amps, 0.05 amps, or even higher or lower. In certain other embodiments, the efficiency of a pump is measured by flow rates. Thus, it is within the scope of this disclosure to have pumps rated at 2,000 gallons/hour (GPH), 1,500 GPH, 750 GPH, 530 GPH, 500 GPH, 250 GPH, 100 GPH, 50 GPH, 25 GPH, 10 GPH or higher or lower. Those of skill in the art realize that the smaller the tank, the lower the flow rate needed to deice the fluid. For example, a seven foot diameter livestock tank can be deiced with a 500 GPH pump or higher. A twelve foot diameter livestock tank can be deiced with a 750 GPH pump or higher. An eighteen to twenty foot diameter livestock tank can be deiced with a 1,500 GPH pump or higher. However, at any speed, the pump should be able to sufficiently move enough fluid to deice the fluid when the ambient temperature is below freezing. Where the fluid is water in a livestock watering tank, the pump should operate to deice the water to the extent that animals can drink ad libitum in sub-freezing temperatures.

As exemplified in FIG. 1, by connecting the recirculating pump to the wall 17 or floor 18 of a container 12, the user can configure the recirculating pump 10 to optimally recirculate fluid 11. For example, in FIG. 1, the recirculating pump 10 is attached to a wall 17 of a container 12 such that the recirculating pump 10 recirculates fluid at the surface 19 of the container 12. While recirculation of a fluid throughout a container 12 can be accomplished by placing a recirculating pump on the bottom of a container 18, certain other configurations can increase the operating efficiency of the system. Thus in some embodiments, fluid recirculation occurs primarily near the surface of the fluid 19. For example, where the recirculating pump's fluid intake 13 is located near the surface 19 of the fluid and the recirculating pump's fluid output 14 is also located near the surface 19 fluid can be recirculated at the surface 19 of the fluid.

As shown in FIG. 1, the means to attach a recirculating pump 10 to a container 12 can be a bracket 15 configured to hold a recirculating pump at the appropriate level in the tank. Thus, in certain embodiments, the depth at which a recirculating pump 10 is immersed can be reconfigured by changing the depth of the bracket according to the user's needs. In certain other embodiments, instead of using a bracket, the recirculating pump is attached to a floating member such as, for example, an air filled tube or foam. In certain other embodiments, the recirculating pump attached to the float is also attached to the tank wall by an armature, thereby limiting movement of the floating recirculating pump within the container. An armature can allow the floating recirculating pump to be fixed to the tank but also allow the recirculating pump to be maintained at the same depth even when water levels changes over time. In yet other embodiments, a magnetic attachment can be used instead of a bracket to secure the recirculating pump. In yet other embodiments, other attachment means known to those of skill in the art may be used including for example, adhesives, hook and loop fasteners, bolts, screws or a combination thereof. Although a pump can be permanently attached to a fluid-filled container by any means, in certain embodiments, the pump can be designed to be removable and transportable, thus reversible attachment means known to those of skill in the art as well as those disclosed herein may be used. Those of skill in the art also recognize that any means of attachment, including uses of brackets disclosed herein, should be resistant to rust and, thus, may be manufactured from any rust-proof or rust-resistant material including, but not limited to, plastic, polyvinyl chloride, galvanized metal, stainless steel, aluminum, or any other such material.

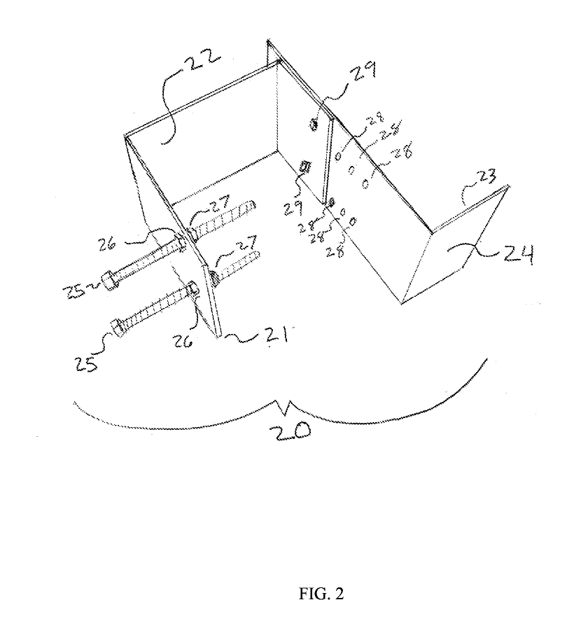

As shown in FIG. 2, a bracket may be used to immerse a recirculating pump at a pre-determined depth in an open-top liquid-filled container in need of deicing. Specifically, the bracket 20 comprises a first metal plate 21 having a “C” bend 22 joined to a second plate 23 having a shelf 24 formed from an “L” bend in a metal plate, wherein the shelf 24 is configured such that an immersed recirculating pump (not shown) can rest on the shelf 24 or otherwise be attached by any means known in the art. The first plate 21 is configured to hang at the “C” bend 22 over the lip of an open-top container (not shown) and is further secured to the container (not shown) by retaining bolts 25 disposed laterally through the first plate 21, and fixed in position by retaining nuts 26 and 27 threaded over the retaining bolts 25. Thus, when mounted, the distal threaded ends of the bolts 25 are in contact with the container wall (not shown) thereby clamping the bracket to the container.

The first plate 21 is joined to the second plate 22 by threading adjustment bolts (not shown) through bolt receivers 28 in the second plate 2 drilled at pre-determined distances distal to the shelf 4 and bolt receivers (not shown) drilled into the first plate 21 and secured by nuts 29 welded to the first plate 21 over the bolt receivers in the first plate 21. Such bolt receivers 28 in the second plate 22 are configured in pairs in order to provide additional structural rigidity when the first and second plate are joined together, but such an arrangement in pairs is not necessary for operation of the bracket 20. In the instant embodiment, the pairs of bolt receivers 28 are spaced ¾inches between each pair allowing the first plate 21 and second plate 22 to be joined so as to allow the user to control the depth of the shelf on which the recirculating pump will rest in ¾inch increments. In FIG. 2, the user has nine separate recirculating pump immersion depths available by means of the nine pairs of bolt receivers 28 spaced in ¾inch increments. In certain other embodiments, seven pairs of bolt receivers spaced at 1 inch are contemplated, as well as any other configurable device allowing users to position the depth of the recirculating pump.

While fluid recirculation at any depth or direction may be used to impart kinetic energy to deice a fluid, certain embodiments disclosed herein comprise fluid recirculation at or near the surface of a fluid. In certain embodiments, the direction of fluid flow can be primarily parallel to the fluid surface and, thus, circulate water around the circumference of the tank as well as through the depth of the fluid. By recirculating water near the surface, the effects of evaporative cooling can be reduced, as well as reducing icing on the walls of the container.

Additionally, by directing water flow, circumferential fluid flow within a container can be obtained. While any flow direction would operate to deice the fluid including water column mixing, circumferential water flow at or near the surface of the fluid has additional advantages over thermal systems. Specifically, where the container is a watering tank for livestock, circumferential water flow forces any residual ice that may have formed into the center of the container of the water. Thus, the animals are able to drink from any position at the edge of the tank. Additionally, once the water has been placed in motion, the momentum of the uniformly moving water reduces the load on a pump thereby further increasing the efficiency of the system. Conversely, thermal systems only melt a warm-water hole in freezing livestock water tanks, effectively forcing animals to drink from a small section of the tank.

As such, in certain embodiments, a pump is located at or near the fluid surface. For example, the fluid output of a recirculating pump can be located at the surface of the fluid. The output may also be placed at not more than ¼ inches, ½ inches, ¾inches, 1 inch, 1¼ inches, 1½ inches, 1¾ inches, 2 inches, 2¼ inches, 2½ inches, 2¾ inches, or 3 inches below the surface of the water. Similarly, the intake for a recirculating pump can be at the surface of a fluid. The intake may also be placed at not more than ¼ inches, ½ inches, ¾inches, 1 inch, 1¼ inches, 1½ inches, 1¾ inches, 2 inches, 2¼ inches, 2½ inches, 2¾ inches, or 3 inches, including where the intake is at or below the output depth level. In certain embodiments, the intake can be located at any depth, including on the bottom of a fluid container. Fixed depths relative to the water surface level are especially useful in deicing a fluid such as water where the fluid container is a livestock watering tank which automatically maintains preset water levels over time and in tanks where the recirculating pump is attached to a floating member.

It is noted that the placement of the intake and output nozzles are the elements imparting kinetic energy into the fluid by a recirculating pump. As such, the recirculating pump itself need not be immersed and may be located even outside the water container. Indeed, it is specifically disclosed herein that a kinetic deicing system may be integrated as part of the container for the fluid, including for example a livestock watering tank comprising an integrated kinetic deicing system. It is also contemplated that as long as the intake and output are recirculating water within the container, the disclosed system is operative and thus not limited by the manner, location, or type of device in which kinetic energy is imparted into the fluid.

In certain embodiments, the deicing system described herein operates without the need for inputting thermal energy into the fluid. While a heater may optionally be attached to the kinetic deicing system disclosed herein, such a heater is not necessary for deicing to occur. Indeed, addition of a heater to the kinetic deicing system described herein obviates many of the advantages of the kinetic system including the reduction of power use. Thus, in some embodiments, thermal elements including heaters are specifically excluded from the deicing system disclosed herein. As such, a kinetic deicing system is to be construed as a system relying solely or primarily on imparting kinetic energy to a fluid to deice a fluid. By imparting kinetic energy into a fluid, crystallization of the fluid can be prevented even when the fluid temperature drops below its freezing point. Such an effect of fluid being maintained in a liquid state below its freezing point is not possible in a thermal deicing system. Thus, the deicing system can be used in any fluid wherein a liquid state must be maintained below the freezing or gelling point of a fluid such as water, diesel fuel, fuel oil, heating oil, or other fluid.

While a kinetic deicing system can be used to continuously recirculate a fluid, it is also within the scope of the disclosure to allow thermostatic control of the deicing system. Thus, in certain embodiments, a thermostat can be used to switch a pump on or off at certain threshold temperatures. For example, a thermostatic setting at or below 36° F., 35° F., 34° F., 33° F., or 32° F., allows the pump to switch on when the ambient temperature approaches or reaches the freezing point of water. The freezing temperatures at which the pump can operate in water can be 32° F., 31° F., 30° F., 25° F., 20° F., 15° F., 10° F., 5° F. 0° F., −5° F., −10° F., −15° F., −20° F., −25° F., −30° F., or even lower. Specific ranges of temperature wherein deicing occurs includes 32° F. to −30° F.; 32° F. to −20° F.; 32° F. to −10° F.; and increments therebetween. A thermostat can be used to detect the ambient atmospheric temperature or, alternatively, the temperature of the fluid in which a kinetic deicing system is operative.

### Example 1

To deice a seven foot diameter tire water tank for livestock, a 500 GPH marine electric bilge pump was attached to a mounting bracket. Specifically, the pump rested on a bracket comprising a submersible shelf that was attached to an adjustable plate that can optionally be moved upwards and downwards. The adjustment plate was affixed to a bracket which hangs over the edge of the tank. The bracket was secured to the wall of the tank by eyebolts forming a “C”-clamp mechanism, thus allowing the pump to be rigidly immersed just below the surface of the water. The electrical cable of the bilge pump was attached to a 12V DC car battery using battery clips. A thermostat was placed in electrical communication with the battery and the pump to automatically switch on the pump at an air temperature of 35° F. and switch off the pump at an air temperature of 45° F. To provide a recharging source, the battery was also attached to a solar panel to provide electrical regeneration of the battery during the operation of the pump when sufficient sunlight was available.

The system comprising the tire tank was capable of deicing the water at temperatures below 32° F. and was still operational at temperatures of −20° F. The low power consumption of the deicing system allowed the pump to deice the tank for 3-6 days without recharging the battery.

The system induced circumferential water flow uniformly moving the water consistent with rigid-body rotation. Rigid-body fluid rotation occurs where an incompressible fluid such as water rotates around the vertical (z) axis with a constant angular velocity (co). Since the angular velocity in rigid body rotation is conserved in the rotating fluid, the relative height of the water at the rim of the tank was higher than the height of water at axis of rotation as given by ΔH=H−h₀=ω²r²/4 g, where H is the initial (non-rotating) depth of the fluid, h₀ is the depth on the axis, r is the radius of the cylinder, and g is the acceleration of gravity. Similarly, the water pressure at the edge and bottom of the tank was higher than the water at the axis of rotation and fluid surface as given by p=(ρω²r²/2)−yz.

The water in the tire tank was observed to rotate at a substantially constant angular velocity about the axis of the tire tank. Such rigid-body rotation is distinguishable from vortex rotation where the fluid at the center of the rotational axis has a substantially greater angular velocity than fluid rotating at the rim, as would be observed, for example, when water accelerates to drain through an opening. The tire tank was non-rotational, so drag was a real-world factor lessening the angular momentum of water at the edge of the tank relative to the water at the axis of rotation compared to the perfect rigid body equations. However, the observed drag led to additional advantages for the particular applications for deicing water.

It was observed that ice particles and fallen snow accumulated at the center of the water in the tire tank instead of accumulating at the edge of the tank. This result was surprising as well as being highly advantageous. During winter, the animals no longer needed to cluster at particular positions around the tank to drink and avoid ice. Instead, the tire tank system allowed the animals to fan out around the entire circumference of the tank just as if they would during the warmer months.

At least three parameters of the tire tank's deicing design promoting rigid body rotation led to the surprising and advantageous results. First, because rigid body rotation curved the water surface into a meniscus, gravity naturally pulled snow and ice to the lowest point at the center of fluid rotation in the tank. Secondly, because rigid body rotation increased the water pressure outwards from the axis of fluid rotation, submerged snow and ice particles were buoyed into the center of the tank by the decreasing pressure gradient. Finally, because the rotating water dragged against the non-rotating tank, friction caused entropy to increase at the edge and bottom of the tank relative to water at the center of the tank. Such increased entropy of water along the circumference of the tank relative to the center of the tank disfavored ice nucleation and crystal growth where the animals drink at the edge of the tank.

Other modifications and embodiments of the invention will come to mind in one skilled in the art to which this invention pertains having the benefit of the teachings presented herein. Therefore, it is to be understood that the invention is not to be limited to the specific embodiments disclosed. Although specific terms are employed, they are used in generic and descriptive sense only and not for purposes of limitation, and that modifications and embodiments are intended to be included within the scope of the appended claims.

What is claimed is:

1. A kinetic deicing system comprising, a pump in a contained fluid wherein the fluid is at a temperature below a freezing point of the fluid; wherein the pump is in electrical communication with an electrical current source; and wherein the pump circulates the fluid circumferentially thereby deicing the contained fluid.

2. The kinetic deicing system of claim 1, wherein the contained fluid is water and residual ice formation is forced to a center of the contained fluid.

3. The kinetic deicing system of claim 2, wherein the water is at a temperature below the freezing point of the water.

4. The kinetic deicing system of claim 2, wherein the water is contained in an open-top receptacle selected from the group consisting of a livestock water trough, water tank, bucket, pond, pool, and birdbath.

5. The kinetic deicing system of claim 1, wherein the pump is a recirculating pump that recirculates the fluid by means of an impeller, propeller, jet, peristaltic pump, bilge pump, piston pump, or a combination thereof.

6. The kinetic deicing system of claim 1, wherein the pump recirculates the fluid at a rate of 2,000 gallons/hour (GPH), 1,500 GPH, 530 GPH, 500 GPH, 250 GPH, 100 GPH, 50 GPH, 25 GPH, or 10 GPH.

7. The kinetic deicing system of claim 1, wherein the pump is in electrical communication with a DC current source.

8. The kinetic deicing system of claim 7, wherein the DC current source is regenerated by a wind generator, a solar panel, or a combination thereof.

9. The kinetic deicing system of claim 1, wherein the pump is in electrical communication with an AC current source.

10. The kinetic deicing system of claim 1, wherein circulation is controlled by a thermostatic control device in electrical communication with the pump.

11. A kinetic deicing system consisting essentially of: a pump circulating a contained fluid wherein the fluid is at a temperature below a freezing point of the fluid; wherein the pump is in electrical communication with an electrical current source; and wherein the pump circulates the fluid circumferentially at a rate that deices the contained fluid.

12. A method of deicing a contained fluid comprising, circulating the fluid circumferentially in a container wherein the fluid is at a temperature below a freezing point of the fluid; and circulating the fluid at a rate that maintains the fluid in a liquid phase.

13. The method of claim 12, wherein the contained fluid is water and residual ice formation is forced to a center of the contained fluid.

14. The method of claim 13, wherein the water is contained in an open-top receptacle selected from the group consisting of a livestock water trough, water tank, bucket, pond, pool, and birdbath.

15. The method of claim 12, wherein the fluid is circulated by a recirculating pump that recirculates the fluid by means of an impeller, propeller, jet, peristaltic pump, bilge pump, piston pump, or a combination thereof.

16. The method of claim 12, wherein the fluid is recirculated at the rate of 2,000 gallons/hour (GPH), 1,500 GPH, 530 GPH, 500 GPH, 250 GPH, 100 GPH, 50 GPH, 25 GPH, or 10 GPH.

17. The method of claim 12, wherein circulation occurs by means of a pump in electrical communication with a DC current source.

18. The method of claim 17, wherein the DC current source is regenerated by a wind generator, a solar panel, or a combination thereof.

19. The method of claim 12, wherein circulation occurs by means of a pump in electrical communication with an AC current source.

20. The method of claim 12, wherein circulation is under regulation of a thermostat.
